(19) United States
(12) Patent Application Publication
(10) Pub. No.: US 2012/0086558 A1
(43) Pub. Date: Apr. 12, 2012

(54) Lane Position Detection Arrangement Using Radio Frequency Identification

(75) Inventor: James M. Teske, Howell, MI (US)

(73) Assignee: FEDERAL SIGNAL CORPORATION, Oak Brook, IL (US)

(21) Appl. No.: 12/900,684

(22) Filed: Oct. 8, 2010

(51) Int. Cl. H04Q 5/22

(52) U.S. Cl. 340/10.4

(57) ABSTRACT

A lane position detection system includes one or more RFID tags positioned at stationary locations along a traffic lane, and an RFID reader positioned and oriented near the traffic lane to interrogate the one or more RFID tags. A vehicle can be detected in the traffic lane when the RFID reader fails to receive a response from at least one of the RFID tags.

### BACKGROUND

Most modern parking systems are partially or fully automated. For example, parking garages typically have entrance meters that allow a vehicle to obtain a ticket as the vehicle approaches the garage. Once the ticket is taken by the driver, the vehicle can enter the garage. Some systems also allow the driver to automatically pay a parking fee prior to leaving the garage.

As part of these automated systems, it is necessary to account for the total occupancy of the garage. For example, it is necessary to provide indicators when the garage is reaching capacity so that the number of vehicles that are allowed to enter the garage is controlled. Further, it can be important for revenue and accounting purposes to accurately account for the number of vehicles within the garage at given points in time.

One method of determining occupancy in a parking garage is detecting vehicles entering and exiting the garage. Existing systems use inductive loop sensors that are embedded in the pavement forming a traffic lane at parking garage entrances and exits, to detect a vehicle's presence when the vehicle is roughly overhead. During operation, a loop sensor generates an oscillating inductive field. When a vehicle (or other metal object) passes over an inductive loop sensor, the frequency of the inductive field changes; when that change is sufficiently large, it is assumed that the change is due to a vehicle passing overhead, and the vehicle is registered.

Loop sensors can be sensitive to environmental changes, such as extreme temperature changes or lightning conditions. Loop sensors can also suffer from cross-coupled frequencies between multiple sensors in a lane, or from adjoining lanes. Additionally, loop sensors can provide different results for vehicles with different ground clearances, and for vehicles of various sizes and materials. Additionally, the presence of rebar or other metals, such as conduit, underneath a loop can also affect loop readings.

For these and other reasons, improvements are desirable.

### SUMMARY

In accordance with the following disclosure, the above and other issues are addressed by the following:

In one aspect, a lane position detection system includes one or more RFID tags positioned at stationary locations along a traffic lane, and an RFID reader positioned and oriented near the traffic lane to interrogate the one or more RFID tags. A vehicle is detected in the traffic lane when the RFID reader fails to receive a response from at least one of the one or more RFID tags.

In another aspect, a parking garage includes a traffic lane providing vehicular access to a plurality of parking spaces, one or more RFID tags positioned at stationary locations along the traffic lane, and an RFID reader positioned and oriented near the traffic lane to interrogate the one or more RFID tags. The RFID reader detects presence of a vehicle when the RFID reader fails to receive a response from at least one of the one or more RFID tags.

In yet another aspect, a method for detecting a vehicle in a traffic lane includes interrogating one or more RFID tags positioned at stationary locations along a traffic lane, and determining that no vehicle is present when a response from each of the one or more RFID tags is received. The method further includes determining the presence of a vehicle when a response is not received from at least one of the one or more RFID tags.

### BRIEF DESCRIPTION OF THE DRAWINGS

FIG. 1 is a schematic view of a parking garage, according to an example embodiment of the present disclosure;

FIG. 2 is a side view of an example parking lane providing access to the parking garage, according to an example embodiment of the present disclosure;

FIG. 3 is a side view of the traffic lane of FIG. 2 with a vehicle present in the lane;

FIG. 4 is a schematic top view of a parking lane in which vehicles can be detected, according to a possible embodiment of the present disclosure;

FIG. 5 is a schematic top view of a parking lane in which vehicles can be detected, according to a second possible embodiment of the present disclosure;

FIG. 6 is a schematic top view of a parking lane in which vehicles can be detected, according to a third possible embodiment of the present disclosure;

FIG. 7 is a flowchart of a method for tracking vehicles in a parking lane, according to a possible embodiment of the present disclosure; and

FIG. 8 is a flowchart of an example method for determining the presence of a vehicle, according to a possible embodiment of the present disclosure.

### DETAILED DESCRIPTION

Various embodiments of the present disclosure will be described in detail with reference to the drawings, wherein like reference numerals represent like parts and assemblies throughout the several views. Reference to various embodiments does not limit the scope of the disclosure. Additionally, any examples set forth in this specification are not intended to be limiting and merely set forth some of the many possible embodiments for the present disclosure.

In general, the present disclosure relates to a lane position detection system using radio frequency identification. Radio frequency identification (RFID) readers and tags are positioned along a traffic lane, such as an entrance/exit lane of a parking garage.

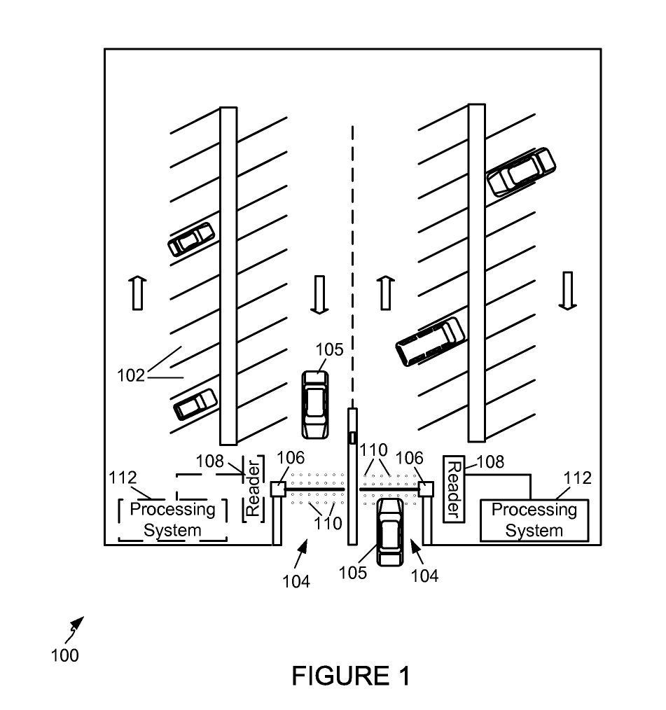

Referring now to FIG. 1, a parking garage 100 is illustrated, according to a possible embodiment of the present disclosure. The garage 100 includes a plurality of parking spaces 102, as well as one or more traffic lanes useable to access the parking spaces 102 within the garage 100. The parking spaces 102 can take any of a number of forms. In the embodiment shown, the parking spaces 102 represent a single-level, angle parking configuration; however, in other arrangements, multi-level structures, and structures using “straight-in” parking spaces could be used as well.

In the embodiment shown, one entrance traffic lane 104a is shown, as well as one exit traffic lane 104b (collectively referred to as “traffic lanes” 104). However, it is understood that, depending upon the configuration and capacity of the garage 100, additional entrance or exit lanes could be used as well.

Each of the traffic lanes 104 can be denoted by markings on pavement or barriers formed in the garage 100, including walls, medians, booths, or other structures. Optionally, and in the embodiment shown, the traffic lanes 104 include gates 106, used to regulate passage of motor vehicles into and out of the garage. In typical arrangements, the gates 106 are arranged to open and close, allowing one vehicle at a time to enter or exit the garage 100.

To detect vehicles (e.g., example vehicles 105 in the traffic lanes and within the garage 100) as they approach the gates, an RFID reader 108 is positioned and oriented toward the traffic lane 104. One or more RFID tags 110 are disposed along the traffic lane. The RFID tags 110 are, in the embodiment shown, placed in stationary positions in the lane 104 on an opposite side of the lane from the RFID reader 108.

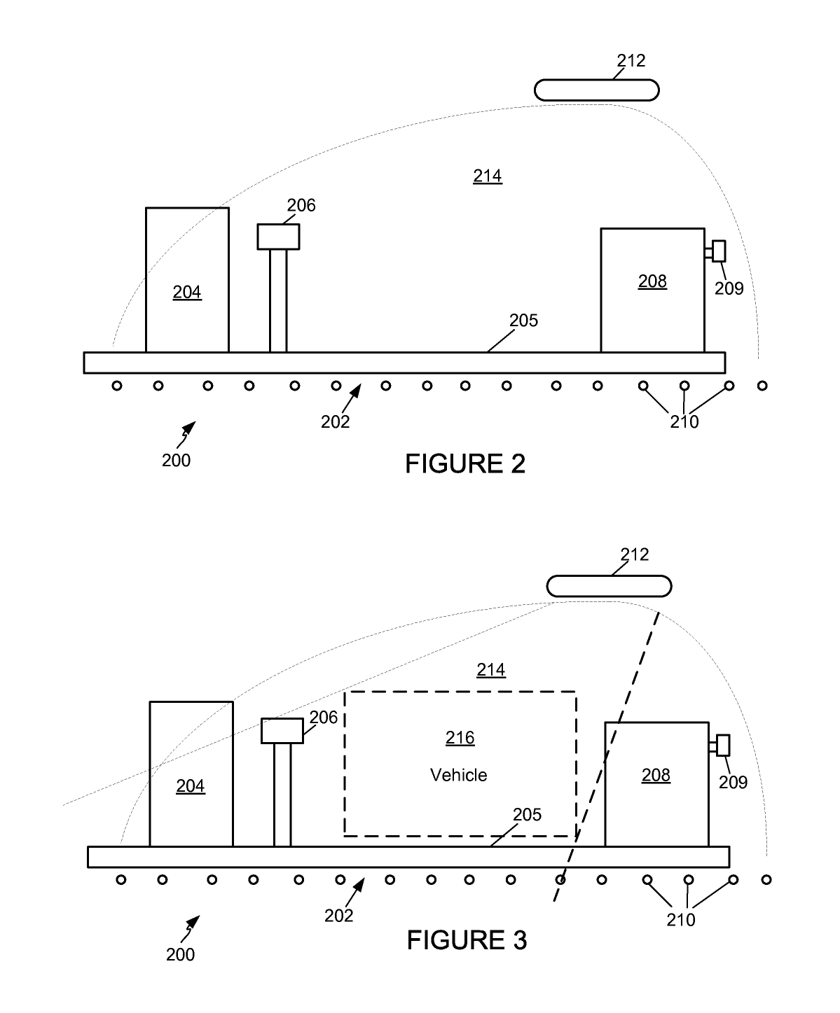

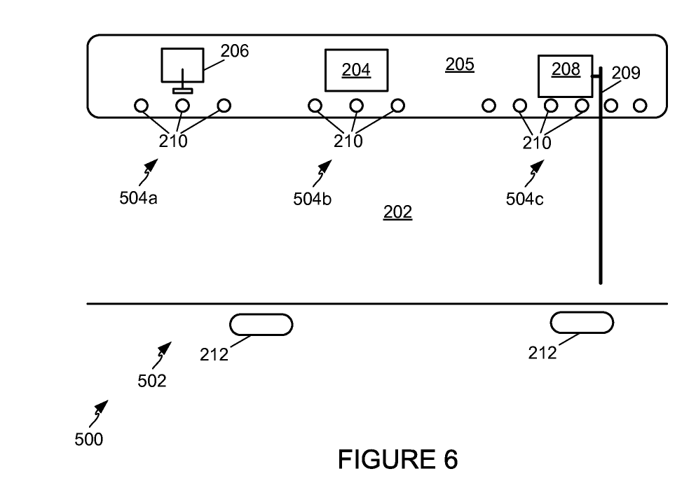

For example, in certain embodiments (such as in FIGS. 2-5, below), the RFID tags 110 are embedded within the pavement of the lane itself, and the RFID reader 108 is mounted above the lane. In this configuration, a vehicle passing through the gate will pass between the RFID reader 108 and at least one of the RFID tags 110, based on the spacing of the RFID tags (e.g., below the reader and above the tags). In another example (such as in FIG. 6), RFID tags 110 can be located alongside the lane, with the reader 108 located along an opposite side of the lane 104. As explained in further detail below, these are only two possible general arrangements of RFID tags and readers; various arrangements of RFID tags and readers as associated with the traffic lane can be used.

During operation an RFID reader 108 will interrogate each of the RFID tags 110 within range of that RFID reader, and will expect responses from each of those tags. This typically occurs many times per second. If no response is received from one or more of the RFID tags 110, it can be assumed that either the interrogation from the RFID reader 108 or the response from the RFID tag 110 has been blocked by an interfering object between the RFID reader and tag (e.g., a vehicle passing through the lane). In this way, vehicles in a traffic lane can be detected and counted as they enter and exit the parking garage 100.

By positioning RFID readers 108 and RFID tags 110 in the traffic lanes 104 of a garage, an estimate of the total occupancy can be made by tracking inbound and outbound traffic. In some examples, the RFID reader 110 reports the occupancy determinations to a processing system 112 of a central parking system. The processing system 160 includes one or more computing devices that are used to compute, display and record occupancy rates and vehicle characteristics, as described further below. Additional advantages of this arrangement are also described below.

In the embodiment shown, separate RFID readers 108 are shown for each traffic lane 104; however, it is understood that a single RFID reader 108 could be positioned and used to communicate with RFID tags in two different lanes. Hence, the second reader 108 is considered optional in the illustrated two traffic lane configuration. Additionally, separate processing systems 112 are illustrated as optionally associated with each RFID reader 108; however, in other embodiments, a single processing system 112 can be communicatively connected to multiple RFID readers, for example all of the RFID readers in a particular lane, or across more than one lane. Furthermore, although in the embodiment shown a large number of RFID tags 110 are illustrated, it is recognized that the parking garage and traffic lanes can include a lane position detection system that includes only one RFID tag per traffic lane. Other embodiments, including embodiments using a plurality of RFID tags in a variety of arrangements, are described below in connection with FIGS. 2-6.

Referring now to FIGS. 2-3, a side view of an example traffic lane 200 useable to detect the presence of a vehicle is shown, according to a possible embodiment of the present disclosure. The traffic lane 200 can, in certain embodiments, correspond to one or more of the traffic lanes 104 discussed above with respect to FIG. 1.

In the embodiment shown, the traffic lane 200 includes a paved area 202 providing entry or exit access for a parking garage, such as the garage 10 of FIG. 1. The traffic lane also optionally includes a kiosk 204, a proximity reader 206, and a gate 208 mounted on a median area 205. The kiosk 204 receives payment or dispenses parking tickets, depending upon the particular function of the traffic lane (e.g., whether the lane is used for entrance or exit from the parking garage. When a user either receives a parking ticket or pays for that parking ticket, the gate 208 actuates a gate arm 209, allowing the vehicle driven by the user to proceed. The proximity reader 206 is configured to read proximity cards, providing an alternative method of actuating the gate for those individuals who repeatedly park in the parking garage (e.g., on a monthly contract or other repeated basis). The gate 208 controls access to the parking garage, opening to allow one car at a time to enter or exit the parking garage.

In the embodiment shown, a plurality of RFID tags 210 are embedded in the paved area 202, and an RFID reader 212 is mounted overhead. The RFID tags 210 and RFID reader 212 are generally analogous to the tags 110 and reader 108 of FIG. 1, above. The RFID reader 212 is mounted such that a directional radio frequency interrogation field 214 transmitted from that reader is broadcast to a number of the RFID tags 210. Although in the embodiment shown each of the RFID tags 210 are within the RF field 214, in other embodiments, this is not necessarily the case; rather, the RFID reader 212 is positioned and oriented to communicate with a consistent number of the RFID tags 210, such that a comparison between sets of tags observed during each interrogation allows tracking of objects passing through the radio frequency interrogation field 214 (i.e., within the one or more traffic lanes 200 covered by such a field).

Comparing FIGS. 2 and 3, it is observed that when a vehicle (illustrated schematically as vehicle 216 of FIG. 3 passes through the traffic lane 200, during each interrogation that vehicle will block messages passing between the RFID reader 212 and RFID tags 210 that are obscured from RF contact with the reader. In the embodiment shown in FIG. 3, the vehicle 216 is present in the lane 200 at a position short of the gate 208; in this arrangement, the RFID reader 212 will not receive responses from RFID tags 210 under the vehicle, which includes a number of the tags depicted to the left of the gate 208 (e.g., behind the gate), but will receive responses from RFID tags ahead of the vehicle 216 and on an opposite side of the gate 208. Based on the selection of responses from the RFID tags 210, the RFID reader 212 (and optionally also an associated processing system, such as that illustrated in FIG. 1) can determine the presence of a vehicle, as well as a number of other features depending upon the specific layout of RFID tags and orientation of the reader. For example, the size and speed of the vehicle can be computed (e.g., based on the number of RFID tags blocked at a given time) as well as the timing in which certain tags are or are not blocked as the vehicle passes through the area of RFID tags.

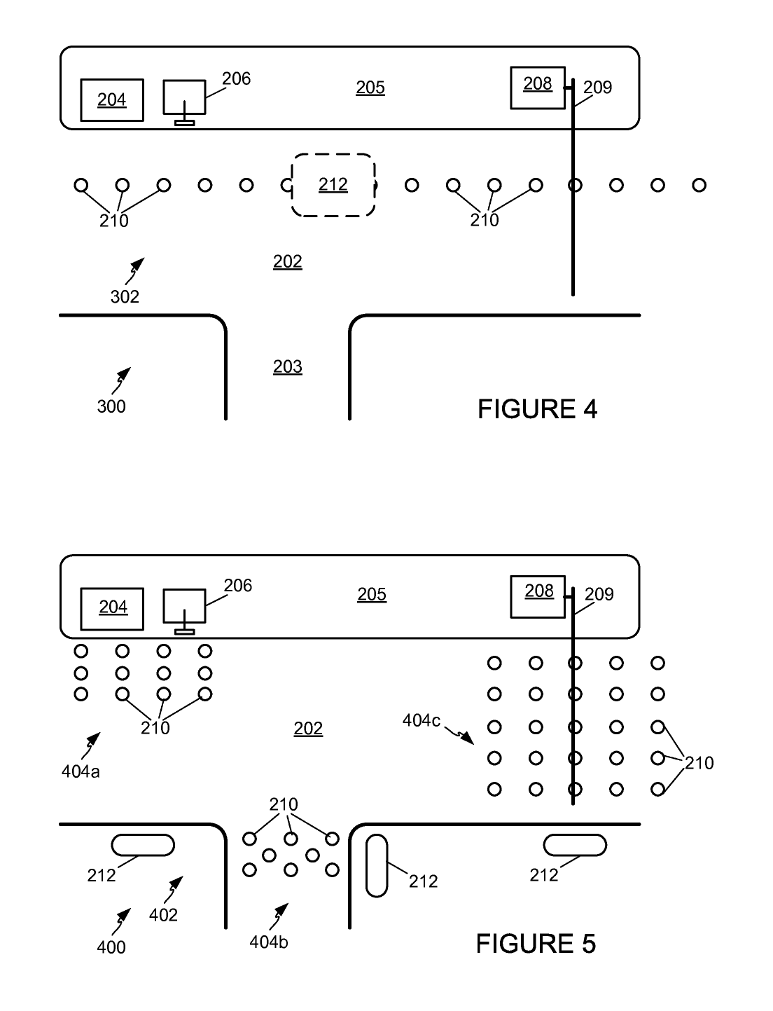

Referring now to FIG. 4, an example traffic lane 300 and associated RFID-based lane position detection system 302 are disclosed. In this example, the traffic lane 300 includes a paved area 202, kiosk 204, proximity reader 206, and gate 208, each of which generally correspond to the analogous components described above with respect to FIGS. 2-3. The RFID-based lane position detection system 302 includes an RFID tag arrangement 304, including a linear arrangement of RFID tags 210. In the embodiment shown, the RFID tag arrangement 304 is disposed generally parallel to a direction of travel of vehicles in the traffic lane 300. The RFID tags 210 can be, in certain embodiments, mounted within openings in the paved area 202. In one example embodiment, the RFID tags 210 are secured within holes drilled into the paved area 202, and covered by an environmental sealant that is transparent to radio frequency signals. Other embodiments for mounting the RFID tags 210 to stationary positions along the paved area 202 are possible as well.

In the embodiment shown, an RFID reader 212 is aligned with the RFID tags 210 and above the paved area 202. In various embodiments, the RFID reader 212 will be located sufficiently high to allow vehicles of varying heights to pass between the RFID reader 212 and the RFID tags 210. In some examples, the RFID reader 312 can be ten to twenty feet above the paved area 202 of the traffic lane 300.

In the embodiment shown, the RFID tag arrangement 304 and RFID reader 212 are located closer to a left side of the paved area 202, for example to ensure that relatively narrow vehicles (e.g., motorcycles or ultracompact cars) are detected when they approach the kiosk 204 or proximity reader 206. However, in alternative embodiments, the particular location of the line or RFID tags 210 can vary.

Referring now to FIG. 5, a further example traffic lane 400 and associated RFID-based lane position detection system 402 are disclosed. In this example, the traffic lane 400 includes a paved area 202, kiosk 204, proximity reader 206, and gate 208, each of which generally correspond to the analogous components described above with respect to FIGS. 2-4. The traffic lane 400 also includes a number of RFID tags 210 and RFID readers 212, arranged to form the RFID-based lane position detection system 402. The traffic lane 400 includes a number of RFID tag arrangements 404a-c. In the embodiment shown, these include a first RFID tag arrangement 404a located proximate to the kiosk 204 and proximity reader 206, a second RFID tag arrangement 404b proximate to the gate 208, and a third RFID tag arrangement 404c disposed across an bypass entrance/exit lane 203 (e.g., used for emergencies or for contract parking users who are not required to bypass the gate 208).

In the embodiment shown, each RFID tag arrangement 404a-c has an associated RFID reader 212. In the embodiment shown, the RFID tag readers are located at a position above and to the side of the lane, oriented downward diagonally toward the lane. A first RFID reader 212 is placed above and to the side of the paved area 202 opposite the kiosk 204 and proximity reader 206. A second RFID reader 212 is placed above and to the side of the paved area 202 across from the gate 208. A third RFID reader is placed above and to the side (either side) of the bypass entrance/exit lane 203, oriented toward tag arrangement 404c. In this embodiment, the RFID tag readers will typically be located sufficiently high above the lane to ensure that vehicles passing through the lane will block RF contact between the reader and the respective RFID tag arrangement 404a-c.

In the embodiment shown, each of the tag arrangements 404a-c are disposed as a two-dimensional array of RFID tags 210. These arrays can be any of a number of sizes. In the embodiment shown, the first RFID tag arrangement 404a is sufficiently long to extend through an area including the kiosk 204 and proximity reader 206, and sufficiently wide and positioned laterally close to the kiosk 204 and proximity reader 206 to capture two-wheel, four-wheel, or other types of vehicles. The second RFID tag arrangement 404b extends across the paved area 202, and from a location on an side of the gate from which vehicles will approach (i.e., the side of the gate toward the kiosk 204 and proximity reader 206), and starts at a distance far enough from the gate arm 209 of gate 208 to allow for interrogation, detection of a vehicle, and, if appropriate, actuation of the gate arm 209 to allow that vehicle to pass. The second RFID tag arrangement 404b also extends to the opposite side of the gate arm 209, thereby allowing the RFID reader 212 and associated second RFID tag arrangement 404b to detect when a vehicle has fully passed the gate, allowing it to close. The third RFID tag arrangement extends across the bypass entrance/exit lane 203 of the paved area 202, and can include any number of RFID tags 210 disposed along any length of the lane sufficient to detect a vehicle passing through that lane.

Comparing the tag arrangements 404a-c of FIG. 5 to the tag arrangement 304 of FIG. 4, it can be seen that the tag arrangement 304 is particularly suited to determining distances between two vehicles, or for detecting the length or speed of a vehicle based on the number and selection of tags blocked at any given time. The tag arrangements 404a-c are specifically adapted to detecting vehicles passing through likely portions of the traffic lane 400, near the kiosk 204, proximity reader 206, bypass entrance/exit lane 203, and gate 208, to prevent missed vehicles. It is recognized that in alternative embodiments, additional RFID tags could be added to either of these arrangements or some combination of RFID tag arrangements could be used, for example to provide the advantages of both arrangements.

Referring now to FIG. 6, a further example traffic lane 500 and associated RFID-based lane position detection system 502 are disclosed. In this example, the traffic lane 500 also includes a paved area 202, kiosk 204, proximity reader 206, and gate 208, each of which generally correspond to the analogous components described above with respect to FIGS. 2-5.

The traffic lane 500 includes a number of RFID tags 210 and RFID readers 212, arranged to form the RFID-based lane position detection system 502. In this embodiment, the traffic lane includes three RFID tag arrangements 504a-c, embedded in or mounted on the median area 205. In this embodiment, a first RFID tag arrangement 504a is embedded in or the median area in the vicinity of the kiosk 204, a second RFID tag arrangement 504b is embedded in the median area in the vicinity of the proximity reader 206, and a third RFID tag arrangement 504c is embedded in the median area in the vicinity of the gate 208.

In the embodiment shown, two RFID readers 212 are associated with the RFID tag arrangements 504a-c, with a first RFID reader 212 located approximately across the paved area 202 from a midpoint between the first and second RFID tag arrangements 504a-b, and a second RFID reader 212 located approximately across the paved area 202 from the gate 208. The first RFID reader 212 is positioned so that reader could detect a vehicle approaching either the kiosk 204 or proximity reader 206. In alternative embodiments, separate RFID readers could be used for each of the RFID tag arrangements 504a-b.

Comparing the arrangement of FIG. 6 to that of FIGS. 2-5, it is recognized that the height requirements for mounting RFID readers is reduced, because the RFID field will be oriented approximately horizontally across the paved area 202 to detect vehicles passing through the traffic lane 500. This may be used, for example, in areas where overhead room is limited, or where RFID readers are more easily mounted or maintained at lower heights.

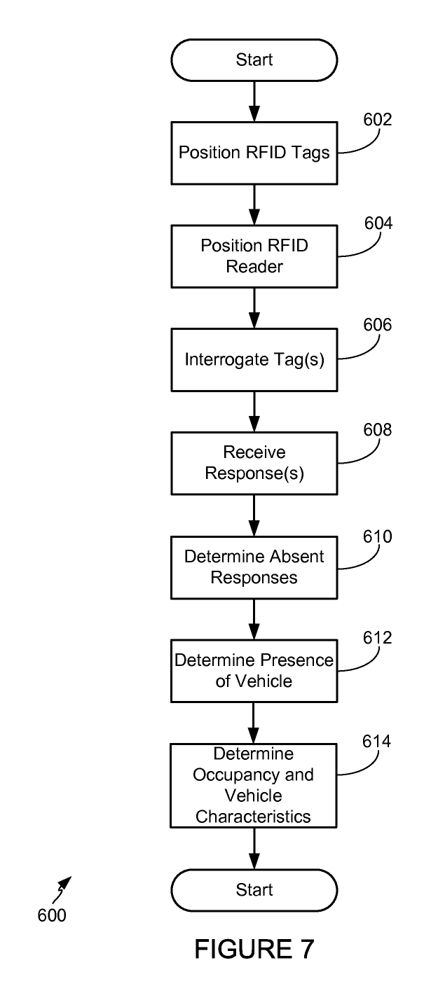

Referring now to FIG. 7, a flowchart of an example method 700 for tracking vehicles in a parking lane is disclosed, according to a possible embodiment of the present disclosure. The method 700 starts by positioning RFID tags 210 (step 702) along a lane in a selected configuration, such as using any of the above RFID tag arrangements described above. This can optionally include mounting or embedding the RFID tags 210 in the paved area 202 or median 205 of a traffic lane.

RFID readers 212 are then positioned and oriented (step 704) to interrogate the positioned RFID tags 210. As discussed above, the numbering, positioning, and orientation of the RFID readers 212 will to some extent depend upon the layout and number of RFID tags selected, and is selected to ensure that vehicles pass between the RFID readers and tags such that interrupted interrogations (e.g., responses not received by the RFID readers) will denote the presence of a vehicle.

Once the RFID tags and readers are positioned along a traffic lane, the readers are activated, and interrogate the tags with which they are associated (step 606). Each reader receives associated responses (step 608) from the RFID tags, and determines the presence or absence of those tags (step 610). When absent tags are detected, the RFID readers (and optionally associated processing units, as illustrated in FIG. 1) determine whether that absence is due to the presence of a vehicle (step 612). This can be done any of a number of ways. For example, a RFID reader 212 or processing unit may require a predetermined number of RFID tags to be blocked (i.e., not responding to interrogations) to conclude that a vehicle is present, or may require that one or more RFID tags 210 are blocked for a predetermined amount of time or number of interrogation cycles to conclude that a vehicle is present. Based on that determination, any of a number of operations can occur within the traffic lane, for example a ticket could be dispensed, a proximity reader could be activated, or a gate could be opened or closed based on the position of the vehicle within the lane.

Optionally, additional information about an overall parking garage can be computed as well (step 614). One example of additional information can include calculations of the overall occupancy or rates of entry/exit for a garage (e.g., based on the total number and timing of entering and exiting vehicles for all traffic lanes). A further example of additional information can include a generated digital representation of a vehicle in the lane based on the particular RFID tags 210 that respond to the RFID reader 212. For example, using the linear arrangement of RFID tags 210 illustrated in FIG. 4, an overall length of a vehicle could be detected by determining the distance across which tags are blocked from responding to RFID reader 212 interrogations.

Alternatively, a two-dimensional arrangement of RFID tags 210 could be used to detect both length and width of a vehicle. Furthermore, other conditions could be detected as well, based on changes in distances between two closely-positioned vehicles in a traffic lane, or changes in interrogation response patterns. For example, varying distances between two closely-positioned vehicles could indicate a tailgating condition, in which one vehicle closely follows a first vehicle to attempt to pass through an activated (e.g., raised) gate without payment, in an attempt to defraud the parking authority. Additionally, a particular interrogation response pattern could indicate a vehicle backing out of a lane to avoid payment. Other vehicle activities could be detected as well, based on calculations performed based on the results of interrogation by RFID readers 212 and subsequent vehicle presence determinations.

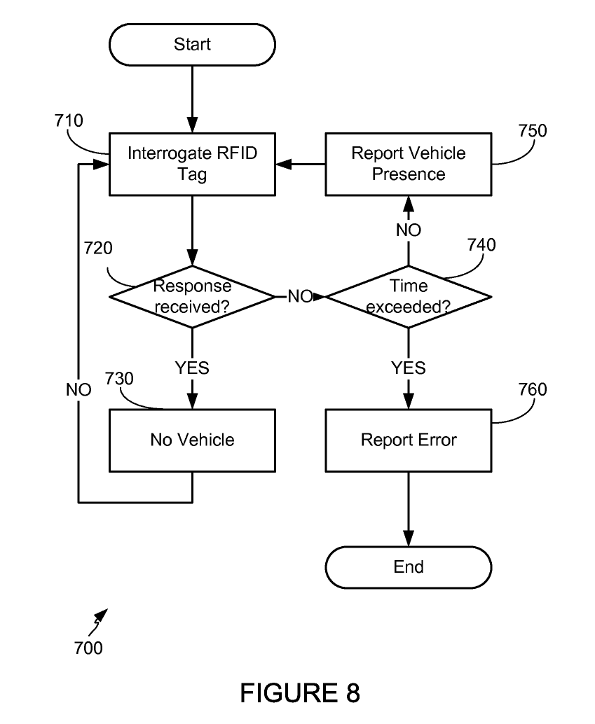

Referring now to FIG. 8, an example method 700 for determining the presence of a vehicle within a parking lane is shown. The method 700 can, in certain embodiments, correspond to performing the interrogation and detection steps 606-612, for example within software of an RFID reader and processing system of the present disclosure. Initially, at operation 710, a plurality of RFID tags are interrogated by an RFID reader. Next, at operation 720, a determination is made regarding whether or not the tags each responded. If not, control is passed back to operation 710, and the RFID tags are interrogated again at some defined frequency (e.g., every millisecond, every second, every five seconds, every ten seconds, etc.).

If the tags do not respond at operation 720, control is instead passed to operation 740. At operation 740, a determination is made regarding whether or not a threshold time period has been exceeded since the last tag response. For example, if a tag fails to respond within a given period of time (e.g., 24 hours, 36 hours, 48 hours etc.), an error status can be provided indicating that the tag could be malfunctioning. If the threshold is exceeded, control is passed to operation 760, and the error status is reported. If the threshold time period has not been exceeded, control is instead passed to operation 750, and the presence of a vehicle in the parking lane is reported, as well as optional additional information regarding the position of the vehicle based on the position of the tag or tags. Next, control is passed back to operation 710 for the next interrogation at the desired frequency.

Referring now to FIGS. 1-8 generally, using the lane position detection systems of the present disclosure including RFID readers and RFID tags allows for increased detail and lower error in detecting vehicles entering and exiting a parking garage, and is less susceptible to external conditions (e.g., weather or interference) affecting its operation.

The RFID tags of the present disclosure (e.g., RFID tags 110, 210) can be active or passive RFID tags. In some examples, the tags are passive IDentity MaX Pro Transponders manufactured by Sirit, Inc. of Toronto, Ontario. Other RFID tags can be used as well.

In example embodiments, the RFID readers of the present disclosure (e.g., RFID readers 108, 212) can be any of a number of RFID reader devices, such as the IDentity™ 4100 UHF Reader manufactured by Sirit, Inc. of Toronto, Ontario. Other RFID readers can be used as well.

Generally, consistent with embodiments of the disclosure, the RFID readers 108, 212 of the present disclosure can include one or more programmable circuits capable of executing program modules. Program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in various types of electrical circuits comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, aspects of the methods described herein can be practiced within a general purpose computer or in any other circuits or systems.

Embodiments of the present disclosure can be implemented as a computer process (method), a computing system, or as an article of manufacture, such as a computer program product or computer readable media. The computer program product may be a computer storage media readable by a computer system and encoding a computer program of instructions for executing a computer process. Accordingly, embodiments of the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media. Further, the disclosed methods' stages may be modified in any manner, including by reordering stages and/or inserting or deleting stages, without departing from the overall concept of the present disclosure.

The above specification, examples and data provide a complete description of the manufacture and use of example embodiments of the present disclosure. Many embodiments of the disclosure can be made without departing from the spirit and scope of the disclosure.

1. A lane position detection system comprising:
one or more RFID tags positioned at stationary locations along a traffic lane;
an RFID reader positioned and oriented near the traffic lane to interrogate the one or more RFID tags,
wherein a vehicle is detected in the traffic lane when the RFID reader fails to receive a response from at least one of the one or more RFID tags.

2. The system of claim 1, wherein the RFID reader periodically interrogates the one or more RFID tags.

3. The system of claim 1, wherein the one or more RFID tags are embedded in pavement forming the traffic lane.

4. The system of claim 3, wherein the RFID reader is positioned over the traffic lane.

5. The system of claim 1, wherein the one or more RFID tags are positioned alongside the traffic lane, and wherein the RFID reader is positioned along an opposite side of the traffic lane from the one or more RFID tags.

6. The system of claim 1, wherein the one or more RFID tags form a tag array including a plurality of RFID tags.

7. The system of claim 6, wherein the tag array is a linear tag array oriented parallel to a direction of travel of traffic in the traffic lane.

8. The system of claim 1, wherein the traffic lane is an entry/exit lane of a parking garage.

9. The system of claim 1, further comprising a controller configured to determine the presence of a vehicle based on responses received by the RFID reader.

10. The system of claim 1, wherein a vehicle positioned in the traffic lane blocks communication between the RFID reader and the at least one of the one or more RFID tags.

11. A parking garage comprising:
a traffic lane providing vehicular access to a plurality of parking spaces;
one or more RFID tags positioned at stationary locations along the traffic lane;
an RFID reader positioned and oriented near the traffic lane to interrogate the one or more RFID tags,
wherein the RFID reader detects presence of a vehicle when the RFID reader fails to receive a response from at least one of the one or more RFID tags.

12. The parking garage of claim 11, wherein the one or more RFID tags are embedded in pavement forming the traffic lane.

13. The parking garage of claim 11, wherein the traffic lane includes a gate, and wherein the one or more RFID tags are positioned near the gate.

14. The parking garage of claim 13, further comprising, upon detecting a vehicle, transmitting a signal to cause the gate to be actuated.

15. The parking garage of claim 11, wherein a vehicle positioned in the traffic lane blocks communication between the RFID reader and at least one of the one or more RFID tags.

16. A method for detecting a vehicle in a traffic lane, the method comprising:
interrogating one or more RFID tags positioned at stationary locations along a traffic lane;
determining that no vehicle is present when a response from each of the one or more RFID tags is received; and
determining the presence of a vehicle when a response is not received from at least one of the one or more RFID tags.

17. The method of claim 16, further comprising embedding the one or more RFID tags into pavement forming the traffic lane.

18. The method of claim 16, further comprising determining a size of a vehicle present in the traffic lane based at least in part on the response not received from the at least one of the one or more RFID tags.

19. The method of claim 16, further comprising distinguishing between two or more vehicles in the traffic lane based on spaces observed to be present between the two or more vehicles.

20. The method of claim 16, further comprising constructing a digital representation of a vehicle present in the traffic lane.
